(19) United States
(12) Patent Application Publication
(10) Pub. No.: US 2004/0170120 A1
(43) Pub. Date: Sep. 2, 2004

(54) Method for modulation

(76) Inventors: Jukka Reunamaki, Tampere (FI); Arto Palin, Viiala (FI); Heikki Berg, Pirkkala (FI); Mauri Honkanen, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/755,871

(22) Filed: Jan. 12, 2004

(30) Foreign Application Priority Data
Jan. 13, 2003 (FI) FI 20030046

(51) Int. Cl. H04L 5/04; H04J 9/00

(52) U.S. Cl. 370/204

(57) ABSTRACT

The present invention relates to a method for modulating a signal in a system providing short-range wireless communication. In the signal, the signal is transmitted in packet format, in which each packet comprises at least a first part and a second part. In the method, the first part and the second part are modulated by using the first modulation method and the second modulation method, respectively. The second modulation method is initialized by using the first part. The invention also relates to a transceiver device and a wireless communication system, in which the method is applied.

### CROSS-REFERENCE TO RELATED APPLICATIONS

This application claims priority under 35 USC §119 to Finnish Patent Application No. 20030046 filed on Jan. 13, 2003.

### FIELD OF THE INVENTION

The present invention relates to a method and a device for implementing the method, for modulating signals in a packet-based wireless communication system providing short-range wireless communication, wherein each packet comprises at least a first part and a second part. The invention also relates to a transceiver device for modulating/demodulating a signal in a system providing short-range wireless communication, which device comprises transmission means for transmitting the signal in packet format, wherein each packet comprises at least a first part and a second part. The invention also relates to a wireless communication system which comprises at least one wireless transmitter device for signal modulation and at least one wireless receiver device for signal demodulation for short-range wireless communication, which wireless communication system comprises transmission means for transmitting a signal in packet format, wherein each packet comprises at least a first part and a second part.

### BACKGROUND OF THE INVENTION

The transmission of modulated signals in a packet based communication system is used, for example, between devices in short-range wireless communication systems. When the device communicates and transmits information to other devices in the neighbouring area, the technology is conventionally based on various cables. An arrangement of short-range wireless communication, which has been spread very widely, is the IrDA technology (Infrared Data Association). The IrDA is based on infrared technology, wherein there must be a visual contact between the parties, and the distance is limited. Other short-range wireless communication technologies include, for example, Bluetooth™, WLAN (IEEE 802.11 standard), BRAN (HiperLAN 1/2), and HomeRF™. Bluetooth is a trademark of Bluetooth SIG, Inc. HomeRF is a trademark of HomeRF Working Group, Inc.

The system according to the Bluetooth technology operates in the frequency range of 2.4 GHz, and the service range of Bluetooth devices with normal output is presently some tens of metres. An application field of the Bluetooth technology is to replace cables and the need for a visual contact in the data transmission between devices, such as, for example, mobile communication devices, portable computers, cameras, and earpieces. The Bluetooth arrangement is also applied in applications of home automation with limited visual contact.

In the transmission based on the Bluetooth technology, frequency hopping is used on the ISM (Industrial, Scientific and Medical) frequency band which ranges from 2.4000 to 2.4835 GHz. The number of channels in use at intervals of 1 MHz totals 79. Each channel is divided into time slots, and because of the frequency hopping, the device may change from one channel to another during a connection. The hopping frequency is, in the normal communication mode, 1600 hops per second, and the frequency hopping sequence is different in each piconet. A TDD (Time Division Duplex) connection means that packets are transmitted alternately by the parties of the data transmission connection. There can be 16 different packet types to be transmitted over the Bluetooth interface; the content data can be of two types: synchronous or asynchronous. Devices communicating under the same master constitute a unit which is known as a piconet. A device initiating communication first forms an identified connection in which it is allocated an identification code of three bits. This means that there can be 8 devices in one piconet, one acting as a master and the others as slaves. The first device in the piconet is the master; the slaves will synchronize their internal clocks and their frequency hopping with the master. Several piconets joined together constitute a scatternet. At the same time, the master may support three synchronous connections (suitable for real-time connections) at a rate of 64 kbps (kbit/s) between the master and a slave. Asynchronous connections, in turn, utilize the capacity left over from the synchronous connections. When operating in full capacity, the rate is 723.2 kbps in one direction and 57.6 kbps in the other direction. The capacity can also be divided symmetrically, in which case the rate is 433.9 kbps in each direction.

Data is transferred in packets over the piconet. A typical packet format complying with the Bluetooth technology comprises three parts: an access code, a header, and payload data. The access code and the header are typically of a fixed length. The lengths of the access code and the header are 72 bits and 54 bits, respectively. The length of payload data may vary from 0 to 2745 bits. Various packet types can be formed depending on the parts included in the packet. The packet may comprise the access code alone, the access code and the header, or all the three parts, i.e. the access code, the header and the payload data.

Each packet starts with the access code. If the access code is followed by a header, the length of the access code is 72 bits. In other cases, the length of the access code is 68 bits. The access code is used, for example, for synchronization and for identification. By means of the access code, it is possible to identify all packets which are transferred over the channel of the piconet. All the packets to be transferred over the piconet contain the same access code. A sliding correlator in the receiver of the Bluetooth device correlates the access codes of received packets to determine the correct scheduling of the reception at the receiver. The access code is also used for paging and inquiry functions, wherein the access code, as such, represents a signalling message, and the message does not include any header or payload data. At the time of making the invention, three different access code types have been defined:

Channel Access Code (CAC)

Device Access Code (DAC)

Inquiry Access Code (IAC)

The channel access code will identify the piconet. This code is used in all packets transferred over the channel of the piconet. The device access code is used in certain signalling methods, for example, for the paging of a given device type and for responding to the paging. The inquiry access code is used in events relating to general paging.

The header includes link control information and comprises six fields:

| | |
|---|---|
| AM_ADDR | active member address |
| TYPE | type code |
| FLOW | flow control |
| ARQN | acknowledgement indication |
| SEQN | sequence number |
| HEC | error check |

The active member address can be used to distinguish between different communication devices in the piconet. The type code tells the packet type in question and also how many time slots said packet will take. Flow control can be used to interrupt data transmission, when necessary, if the buffer is full at the receiving end. The acknowledgement indication is used to inform the transmitting end of a successful or failed transmission. The sequence number can be used to arrange the data packets in a given order. The header also includes an error check field which can be used to check the integrity of the header.

According to the present Bluetooth specification, the signals of the transmitting end are modulated for the transmission by using the GFSK (Gaussian Frequency Shift Keying) modulation method. In fact, the practice is that, in the modulation method, the data bits ‘1’ and ‘0’ are represented as a positive frequency shift and a negative frequency shift, respectively, in relation to the actual transmission frequency. In addition, it has also been defined that the absolute frequency shift achieved in the modulation of the bit string ‘1010’ is at least 80% of the absolute frequency change which is achieved in the modulation of the bit string ‘00001111’. By means of this modulation method, the total transmission rate is 1 Mbit/s, which corresponds to the symbol rate of 1 Ms/s.

In general, the aim is to at least double the present average data rate to achieve the transfer rate of 2 Mbit/s or even higher rates at minimum costs. It is also very important that the system of the higher data rate is compatible with the present specification, to make sure that also current devices can operate as slaves in a piconet comprising devices of a higher data rate.

In addition, modifications are required for the synchronization of the devices in the piconet. In piconets of prior art, the synchronization of devices is based on an access code which is transmitted in the first part of each packet by the master of the piconet. For this reason, one should also make sure that devices of the prior art are capable of identifying a transmission code transmitted by a device of a higher data rate. Furthermore, present Bluetooth devices should be capable of decoding the header of a received packet which identifies the slave to which the packet is addressed, as well as the type of the packet in question and thereby also the length of the packet.

To increase the average data rate in the Bluetooth, various alternatives have been considered. To secure compatibility with existing systems, these different alternatives have been based on modulating the access code and the header with a modulation method similar to that presented in the present Bluetooth specification. Only payload data is to be modulated by using a different modulation method to achieve a higher data rate. The use of different modulation methods for the access code/header and payload data requires that the modulation method is changed before modulating payload data of a higher rate. However, the change of the modulation method will require that a given switching time is taken between the modulation of the header and the modulation of the payload data. The switching time is needed for the change of the GFSK signal to the DPSK signal and for the respective change of filters. A Gaussian filter is used for the GFSK modulation, and a raised cosine filter is typically used for DPSK modulation. Some modulation methods may even require the use of a new synchronization part.

One possible way to improve the data rate is to use the π/4-DQPSK (Differential Quadrature Phase Shift Keying) modulation method as the DPSK modulation method, utilizing phase shifts of +135°, +45°, −45° and −135° in the modulation. By taking all the phase shifts in use in the modulation, a higher data rate is achieved, compared with, for example, the two-level GFSK (Gaussian Frequency Shift Keying) modulation method which is defined in the present Bluetooth specification. By modulating the access code and the header by using, in the modulation, only phase shifts of ±45° or phase shifts which correspond to phase changes in the GFSK signal, it is possible to keep all the devices of the piconet synchronized with the master also during the transmission at a higher rate, and to maintain compatibility between devices of different transmission rates. Furthermore, the devices of a conventional transmission rate may save power by being in dormancy (sleep mode) during those time slots in which a higher data rate is used. Also, the frame structure remains similar to the current Bluetooth specification presented above in this description.

### SUMMARY OF THE INVENTION

It is an aim of the present invention to provide an improvement to the prior art and to raise the transfer rate of short-range data transmission connections in a wireless environment.

According to a first aspect of the invention, a method has been implemented for signal modulation in a system providing short-range wireless communication, in which system the signal is transmitted in packet format and each packet comprises at least a first part and a second part. The method according to the invention is primarily characterized in that, in the method, the first part and the second part are modulated by using a first modulation method and a second modulation method, respectively, and wherein said second modulation method is initialized by using said first part.

According to a second aspect of the invention, a transceiver device is implemented for modulating/demodulating a signal in a system providing short-range wireless communication, which device comprises transmission means for transmitting the signal in packet format, and each packet comprises at least a first part and a second part. The transceiver according to the invention is primarily characterized in that the transceiver also comprises modulation means for modulating the first part and the second part by using the first modulation method and the second modulation method, respectively, and means for initializing said second modulation method by using said first part.

According to a third aspect of the invention, a wireless communication system is implemented, which comprises at least one wireless transmitter device for signal modulation and at least one wireless receiver device for signal demodulation in a system providing short-range wireless communication, which system comprises transmission means for transmitting a signal in packet format, and each packet comprises at least a first part and a second part. The transceiver according to the invention is primarily characterized in that the wireless communication system also comprises modulation means for modulating the first part and the second part by using the first modulation method and the second modulation method, respectively, and means for initializing said second modulation method by using said first part.

Considerable advantages are achieved by the present invention. In the application of the method according to the invention, it is possible to improve the modulation of signals in the transmitter and their demodulation in the receiver in such a way that it is possible to raise the rate of transfer over the wireless communication network. The method according to the invention has also the advantage that, in spite of the improvement in the transmission rate, as many devices as possible, not using modulation according to the invention, remain synchronized with the master of the piconet using modulation according to the invention. Another advantage is the straightforwardness and simplicity of the implementation according to the invention.

According to an embodiment of the invention, a part of the packet is modulated by using the GFSK modulation method and a part of the packet is modulated by using the DPSK modulation method. Alternatives for the DPSK modulation method include, for example, the π/4-DQPSK modulation of the 8DPSK modulation. In the GFSK modulation, each bit of information entering the modulator is reflected in the modulated signal one by one, corresponding to a frequency change of a given magnitude in the transmitter signal, depending on the bit value, as described earlier in this application. By this modulation method, the average data rate of about 1 Mbit/s is achieved.

In the π/4-DQPSK modulation, a symbol formed by two bits is represented by one phase shift. In total, there are four possible phase shifts in use: +45°, −45°, +135° and −135°. A possible way of representation is given in the table below, in which the left column shows the symbol of two bits (b₀, b₁) of the information to be modulated, and the right column shows the respective phase shift in the transmitter signal, compared with the phase value of the preceding signal. The constellation pattern of the π/4-DQPSK modulation method is also shown below in FIG. 7 of the present application.

| Symbol (b₀, b₁) | Phase change (deg) |
|---|---|
| (1, 1) | +135 |
| (1, 0) | +45 |
| (0, 0) | −45 |
| (0, 1) | −135 |

By this modulation, a data rate of about 2 Mbit/s is achieved, corresponding to the symbol rate of 1 Ms/s.

In 8DPSK modulation, a symbol formed by three bits is represented by one phase shift. In total, there are eight possible phase shifts in use, for example: 0°, +45°, +90°, +135°, +180°, −45°, −90° and −135°. A possible way of representation is given in the table below, in which the left column shows the symbol of three bits (b₀, b₁, b₂) of the information to be modulated, and the right column shows the respective phase shift in the transmitter signal, compared with the phase value of the preceding signal. The constellation pattern of the 8DPSK modulation method is also shown below in FIG. 8 of this application.

| Symbol (b₀, b₁, b₂) | Phase change (deg) |
|---|---|
| (0, 0, 0) | 0 |
| (0, 0, 1) | +45 |
| (0, 1, 1) | +90 |
| (0, 1, 0) | +135 |
| (1, 1, 0) | +180 |
| (1, 1, 1) | −135 |
| (1, 0, 1) | −90 |
| (1, 0, 0) | −45 |

By this modulation, the data rate of about 3 Mbit/s is achieved, corresponding to the symbol rate of 1 Ms/s.

It will be obvious that even though the phase angles are given as exact degree values in this description, the real phase angles may be slightly different from these values in practical applications. Consequently, the phase angle values must not be interpreted in the restrictive sense, to refer to said exact values only.

### DESCRIPTION OF THE DRAWINGS

In the following, the invention will be described in more detail with reference to the appended drawings, in which

FIG. 1 shows the modulation method of prior art for a packet of a short-range wireless communication system,

FIG. 2 shows a modulation method according to an embodiment of the invention for a packet of a short-range wireless communication system,

FIG. 3 shows the method according to an embodiment of the invention for changing the modulation, in a simplified flow chart,

FIG. 4 shows, in a simplified block diagram, a modulator and a wireless communication device according to an embodiment of the invention,

FIG. 5 shows the method according to a second embodiment of the invention for changing the modulation, in a simplified flow chart,

FIG. 6 shows, in a simplified block diagram, a modulator and a wireless communication device according to a second embodiment of the invention,

FIG. 7 shows constellation points in the π/4-DQPSK modulation method,

FIG. 8 shows constellation points in the 8DPSK modulation method, and

FIG. 9 shows a wireless communication system according to an embodiment of the invention in a simplified diagram.

### DETAILED DESCRIPTION OF THE INVENTION

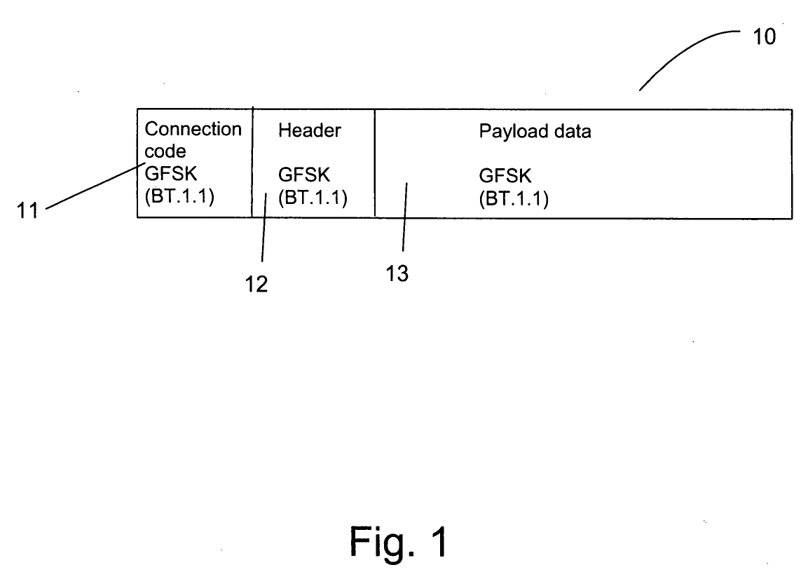

With reference to FIG. 1, in the method of prior art, the whole Bluetooth packet 10 is modulated by using the GFSK (Gaussian Frequency Shift Keying) modulation method. The Bluetooth packet comprises at least an access code part 11, a header part 12 and a payload data part 13.

In the modulation, the binary value ‘1’ is given as a positive frequency deviation in the transmission frequency, and the binary value ‘0’ is given as a negative frequency deviation in the transmission frequency. The frequency deviation is dependent on the used modulation index which, according to the Bluetooth specification, is typically in the range from 0.28 to 0.35, which corresponds to a frequency deviation value in the range from 140 to 175 kHz. By this modulation method, the symbol rate of 1 Ms/s is achieved for the data to be transmitted. The GFSK modulation method is, as such, known for a person skilled in the art, and it does not need to be discussed in more detail in this context.

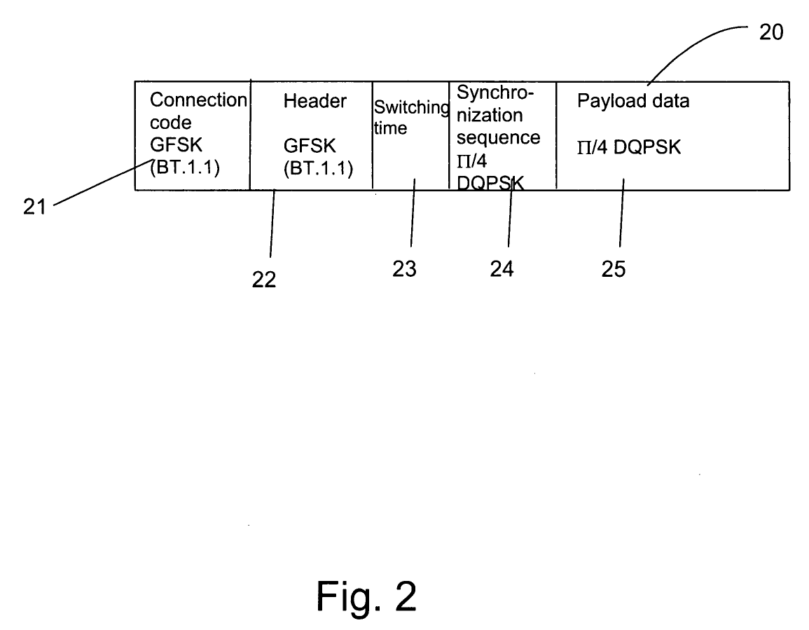

With reference to FIG. 2, in the method according to an embodiment of the invention, an access code part 21 and a header part 22 of the Bluetooth packet 20 are modulated by using the GFSK modulation method, and a synchronization sequence 24 and a payload data part 25 are modulated by using the DPSK modulation method. During the switching time 23, there is no need to transmit anything, but the possible switching time signal must comply with the spectral requirements of the specification. The switching time 23 is particularly useful in a situation in which the receiver is waiting for the DPSK modulated payload data part 25, even though the payload data part 25 is a broadcast type packet which has been modulated by GFSK modulation. This is because all the wireless communication devices of the piconet can demodulate this broadcast type message, irrespective of whether they use the modulation method of the invention or not.

A symbol of the synchronization sequence 24 must be scheduled within 0.25 microseconds from the last symbol of the GFSK modulated header part 22. The synchronization sequence 24 is the same, irrespective of whether the modulation method used is π/4-DQPSK or 8DPSK.

In the method according to an embodiment of the invention, the change of the modulation method is implemented by utilizing the frequency shift at the end of the GFSK modulated part for the initialization of the pulse shaping filter of the linear modulation. If the frequency shift at the end of the GFSK modulated part is positive, the filter initialization is performed by using a symbol string in which there is a positive phase shift between successive symbols. If the frequency shift at the end of the GFSK modulated part is negative, the filter initialization is performed by using a symbol string with a negative phase shift between successive symbols. The symbol string to be used for the initialization can be selected in such a way that the output frequency of the linear modulation largely corresponds to the output frequency of the GFSK modulated part. The aim is to make sure that no abrupt changes occur in the frequency of the transmitted signal when changing the modulation method.

The modulation method can be changed smoothly between the GFSK and the DPSK by securing the continuity of not only the frequency but also the phase. The signal phase which results on the basis of the GFSK modulation is known after the modulation, because the phase is dependent on the data to be transmitted. This phase can be utilized for determining the correct phase shift for the step of starting linear modulation, to maintain the overall phase of the signal continuous. The phase shift is reflected in the receiver as a phase shift in the radio channel, wherein it will not affect the performance of the receiver. The signal amplitudes can be defined to be equal for both modulation methods in the situation of changing the modulation.

As described earlier, in the modulation according to the present Bluetooth specification, the modulation index is defined in the range from 0.28 to 0.35, corresponding to a frequency shift ranging from 140 to 175 kHz. A positive change corresponds to the binary digit ‘1’ and a negative change corresponds to the binary digit ‘0’. In the method according to the invention, the access code 21 and the header 22 are modulated in the same way as in the solution of prior art, but the synchronization sequence 24 and the payload data part 25 are modulated by using the DPSK modulation method, for example π/4-DQPSK (Differential Quadrature Phase Shift Keying), as shown in FIG. 2.

The header part 22 is encoded, according to the Bluetooth specification, always before the modulation by using ⅓ FEC (Forward Error Correction) coding, which means that each bit is repeated three times in a sequence. The purpose of the FEC encoding is to reduce the number of possible retransmissions, and the encoding can also be used for the payload data part 25. Because of the way of encoding the header part 22, the frequency shift receives its highest value from the three encoded bits of the header part, during the last bit. In a normal situation, this is not up-to-date because of the pulse shaping filter, unless three identical bits occur in a sequence. During the last bit of the header part, the frequency shift is from 140 to 175 kHz, which corresponds to a phase shift of 50.4 to 63 degrees during a symbol. However, during random data, the smallest phase shift during a symbol is 29 to 36 degrees in a situation in which the bits are ‘010101’. By selecting the phase shift of 45 degrees when changing the modulation method, an output frequency is achieved which corresponds approximately to the GFSK modulated part. Similarly, by selecting this phase shift when changing the modulation method, the linear filter is initialized with a phase shift similar to what will be, for example, in the π/4-DQPSK modulated part. The phase shift of 45 degrees is positive, if the frequency shift at the end of the GFSK modulated part is positive, and the phase shift is negative, if the frequency shift at the end of the GFSK modulated part is negative. When changing the modulation method, the continuity of the phase is to be maintained by using the end of the GFSK modulated part 22 as the initializing state during the switching time 23 when the 45 degree phase shift is made. Thanks to the phase shift made during the switching time 23, the modulation of the synchronization sequence 23 starts so that the representation of the symbol is phase shifted according to the end of the GFSK modulated part.

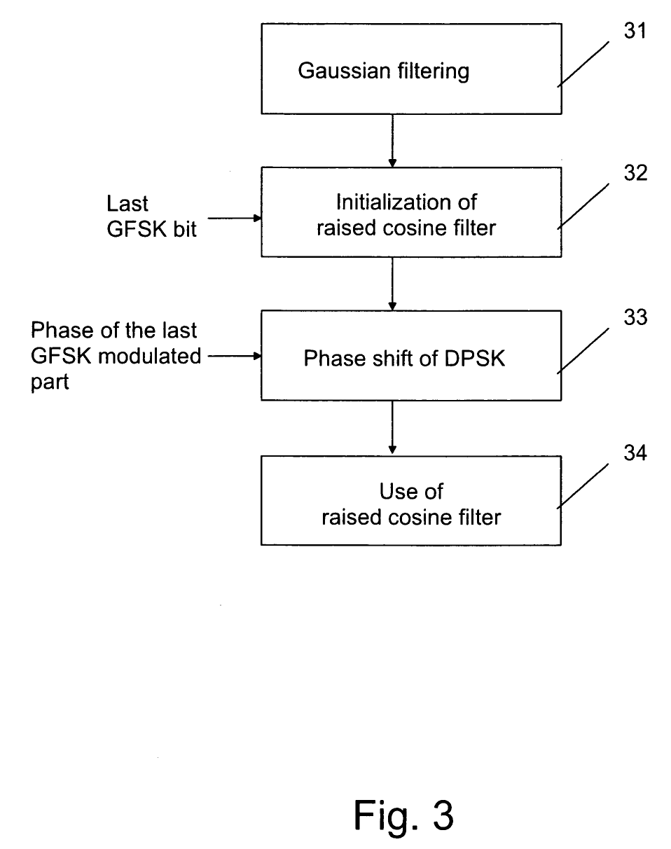

FIG. 3 shows the method according to an embodiment of the invention for changing the modulation, in a simplified flow chart. The beginning of the packet is modulated by the GFSK method by using Gaussian filtering 31. At the stage when the last bit of the GFSK modulated part is known, typically the last bit of the header part 22, the initialization 32 of the raised cosine filter is started with suitable values. Gaussian filtering is used for symbol filtration until the last symbol intended for GFSK modulation has been modulated. After this, during the switching time 23, the DPSK modulator is subjected to a phase shift 33, and the DPSK modulation 34 of the synchronization part 24 is started by using the raised cosine filter. In the phase shifting 33, the phase of the last GFSK symbol is taken as the reference level, and the phase shift of one DPSK symbol is performed. Using this method, the sufficient length for the switching time 23 will be 1 μs, i.e. one symbol, and the implementation is straightforward and simple and offers a possibility to increase the transmission rate.

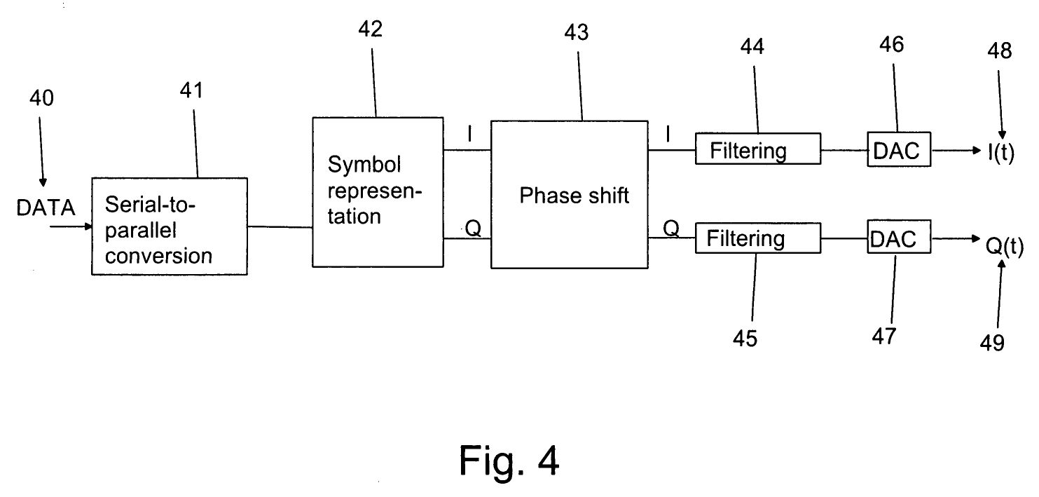

The modulator of the device implementing the method of the invention is shown as a block chart in FIG. 4. The data 40 to be modulated comes in bit format to a serial-to-parallel conversion 41, in which the bit string of serial format is converted to symbols having the width of two bits for π/4-DQPSK modulation, or to symbols having the width of three bits for 8DPSK modulation. In block 42, the symbols are represented, wherein a given phase shift corresponds to a given bit combination in relation to the modulation phase of the preceding symbol in the carrier frequency.

In block 43, the necessary phase shift 33 is performed in such a way that the phase of the last GFSK modulated part is used as the initial phase and, in the phase shift 33, the phase is shifted 45° (π/4) forward or backward, depending on the last GFSK bit and the respective frequency shift. The phase is shifted forward if the frequency change was positive, and the phase is shifted backward if the frequency change was negative. After the phase shift 43, the complex level signal is filtered in such a way that the real element (I) of the signal is filtered by the filter block 44 and the imaginary element (Q) is filtered by the filter block 45. After this, both of the signal elements are converted to the analog format by using conversion blocks 46 and 47, after which the output gives two time-level signals I(t) 48 and Q(t) 49 for transmission.

In the method according to another embodiment of the invention, the change of the modulation method is implemented by initializing the pulse shaping filter of the DPSK modulation by using a series of symbols containing at least one constellation point of the GFSK modulated part from the end of the header part. Consequently, the amplitude and phase of the GFSK modulated signal are sufficiently close to the DPSK modulated signal in view of the smooth change of the modulation method. After the transmission of the GFSK modulated part, the raised cosine filtering is taken into use. As in the first method, also in this second method the aim is that no abrupt frequency changes will occur in the transmitter signal when the modulation method is changed. In this method, the signal phase remains as continuous as possible during the change, because the DPSK modulation is initialized with real samples of the GFSK modulated signal. For as smooth a filter change as possible, the first symbol of the data to be DPSK modulated can be defined to be the next constellation point in the direction of the phase of the GFSK modulated signal.

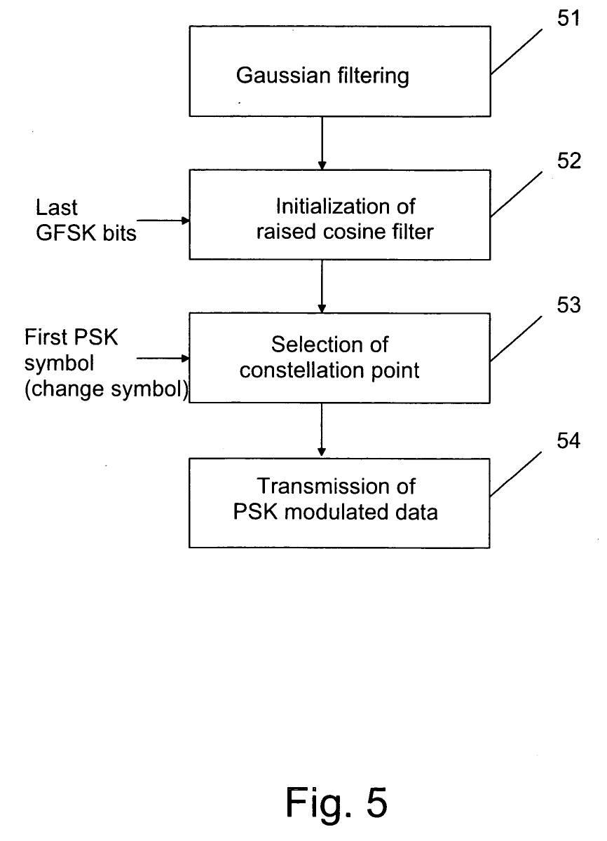

FIG. 5 shows the method according to another embodiment of the invention for changing the modulation, in a simplified flow chart. The beginning of the packet is modulated by the GFSK method by using Gaussian filtering 51. At the stage when the last bits of the GFSK modulated part are known, typically the last bits of the header part 22, the initialization 52 of the raised cosine filter is started with these values. Gaussian filtering is used for symbol filtration until the last symbol intended for GFSK modulation has been modulated. After this, during the switching time 23, one change symbol is input in the DPSK modulator to achieve as good a continuity as possible in the phase. The change symbol can be selected so that it is a PSK modulated symbol which is used for selecting, as the constellation point 53, the next closest point in the direction of the phase of the GFSK modulated signal. In addition, the change symbol simplifies the implementation of the DPSK modulation, because the same constellation points can be used, irrespective of the last phase of the GFSK modulated signal. The transmission of the DPSK modulated data is started in step 54. Also when this method is used, the sufficient length for the switching time 23 will be 1 μs, i.e. one symbol, and the transfer rate can be substantially increased.

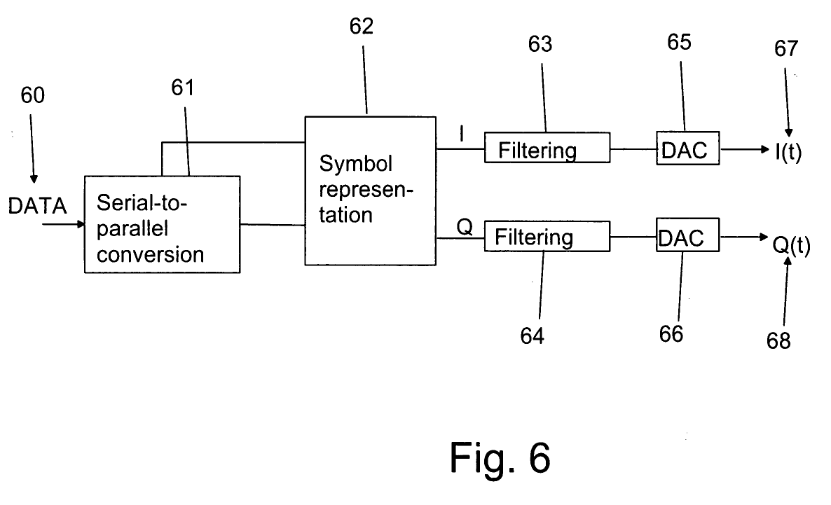

The modulator of the device implementing the method according to another embodiment of the invention is shown as a block chart in FIG. 6. The data 60 to be modulated comes in bit format to a serial-to-parallel conversion 61, in which the bit string of serial format is converted to symbols having the width of two bits for π/4-DQPSK modulation, or to symbols having the width of three bits for 8DPSK modulation. In block 62, the symbols are represented, wherein a given bit combination represents a given phase shift in relation to the modulation phase of the preceding symbol at the carrier frequency. During the switching time 23, the modulator is initialized in such a way that before the transmission of the DPSK modulated data, the raised cosine filter is initialized with the last constellation point of the GFSK modulated part. The complex level signal is filtered in such a way that the real element (I) of the signal is filtered by the filter block 63, and the imaginary element (Q) is filtered by the filter block 64. After this, both of the signal elements are converted to the analog format by using conversion blocks 65 and 66, after which the output gives two time-level signals I(t) 67 and Q(t) 68 for transmission.

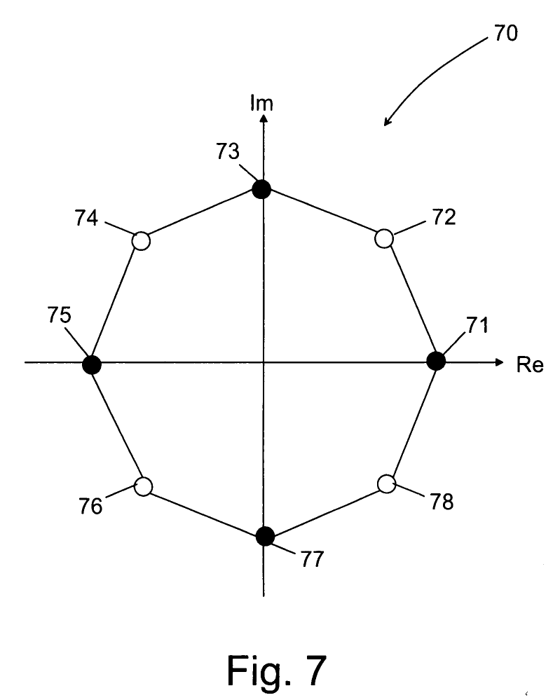

In an embodiment of the invention, the π/4-DQPSK modulation method is used for modulating the synchronization sequence 24 and the payload data part 25. As shown in FIG. 7, this method comprises a constellation pattern 70 with a total of eight phase states 71 to 78, but only four phase shifts. Allowed phase shifts are ±π/4 and ±3π/4. In practice, the constellation thus varies, alternating between the two sets of constellations. The first set of four constellation points consists of black points 71, 73, 75 and 77, and the second set consists of white points 72, 74, 76 and 78. According to the constellation, the first step is to move, for example, from the constellation point 73 to the point 74 (or 72) and then a phase shift of ±π/4 or ±3π/4 is made, according to the bits to be transmitted, wherein the next possible point is 71, 73, 75 or 77.

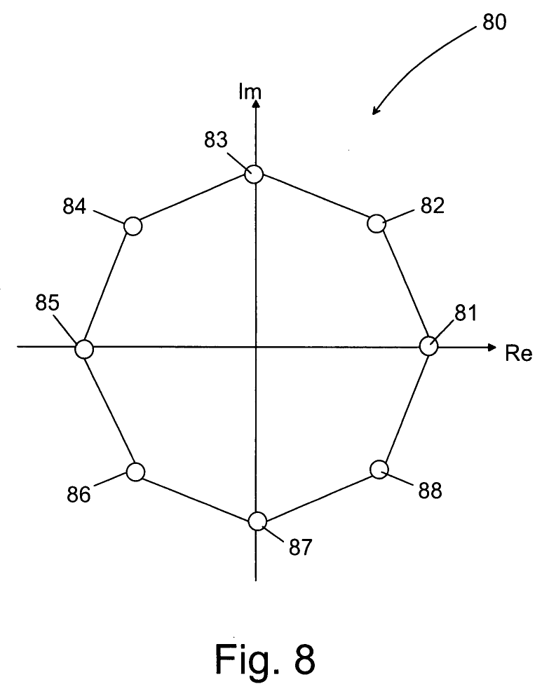

In an embodiment of the invention, the 8DPSK modulation method is used for modulating the synchronization sequence 24 and the payload data part 25. As shown in FIG. 8, this method comprises a constellation pattern 80 with a total of eight phase states 81 to 88. Allowed phase shifts include 0, +π, ±π/4, ±π/2 and ±π/4. According to the constellation, for example, the first step is to move from the constellation point 83 to the point 84 (or 82) and then a phase shift of 0, +π, ±π/4, ±π/2 or ±3π/4 is made, according to the bits to be transmitted, wherein the next possible point is 81, 83, 85, 86, 87, or 88.

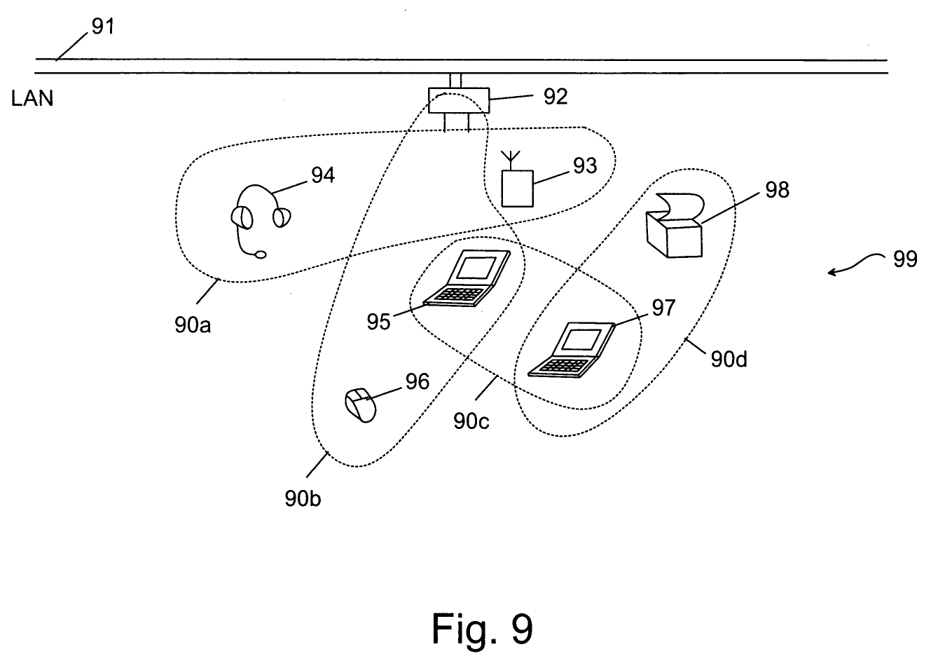

With reference to FIG. 9, a wireless communication system, in which the invention can be applied, is shown in a simplified diagram. The Bluetooth network 99 shown in the figure consists of piconets 90a-d forming scatternets. The piconet 90a comprises a mobile phone 93 and a headset 94 connected to it. The piconet 90b comprises a Bluetooth base station 92, a computer 95 and a computer pointer device, for example a mouse 96. The base station 92 is connected to a local area network (LAN) 91, through which it is possible to communicate further to other base stations, an internal data network and the Internet network.

The piconet 90c comprises two computers 95, 97, and the piconet 90d comprises a computer 97 and a printer 98. The piconets comprise 2 to 8 active devices, of which one acts as a master and the others as slaves. Within the range of the piconet, there may be devices in an inactive “parked” state, which have a connection to the master device but which cannot participate in the communication. The piconet is determined completely according to its master device. This is a device which has created the piconet by initiating a connection to another device. Bluetooth devices, as such, are identical in view of the network; the status of the device in the piconet is determined dynamically. Within the piconet, the devices do not have connections to other devices than the master device which controls the communication. However, the slave devices can also have connections to devices of other piconets. The size of the piconet is limited by the fact that all the slave devices in the network are connected to the master device, wherein the communication channel of the piconet is divided between the slave devices.

The present invention has several advantages over the arrangements of prior art. The invention can be applied in, for example, mobile phones, personal digital assistants and small laptop computers. Alternatively, it can be used in electronic games, in interfaces of various domestic and office electronic devices, such as hi-fi equipment, car stereo equipment and, for example, in multimedia devices used in airplanes.

In this context, the implementation and embodiments of the invention have been presented by means of examples. It will be evident to a person skilled in the art that the invention is not limited to the details of the above-presented embodiments and that the invention can also be implemented in other forms without deviating from the characteristics of the invention. Consequently, the presented embodiments should be considered as being illustrative but not restrictive. The possibilities to implement and use the invention are thus limited by the appended claims only. Thus, also various alternatives to implement the invention, as well as equivalent implementations, defined by the claims fall within the scope of the invention.

1. A method for modulating a signal in a system providing short-range wireless communication, in which method the signal is transmitted in packet format, wherein each packet comprises at least a first part and a second part, the method comprising modulating the first part and the second part by using a first modulation method and a second modulation method, respectively, and initializing said second modulation method by using said first part.

2. The method according to claim 1, wherein a frequency modulation method is used as said first modulation method.

3. The method according to claim 1, wherein a phase modulation method is used as said second modulation method.

4. The method according to claim 1, the first part comprising bits, wherein the last bits of the first part are used for said initialization.

5. The method according to claim 3, further comprising determining the phase of a last signal modulated by the first modulation method in the packet, using the determination to correct the phase of the signal to be modulated between the modulation of said first and second parts, and continuing the modulation of the second part by the phase modulation method by using the corrected signal phase.

6. The method according to claim 1, wherein at least an access code part, a header part, a synchronization sequence and a payload data part are formed for the packet, and that in said first part, the packet code part and the header part of the packet are modulated by using the GFSK modulation method, and in said second part, the synchronization sequence and the payload data part of the packet are modulated by using the DPSK modulation method.

7. The method according to claim 1, wherein a switching time is left between the transmission of said first and second parts.

8. A transceiver device for modulating/demodulating a signal in a system providing short-range wireless communication, which device comprises transmission means for transmitting the signal in packet format, wherein each packet comprises at least a first part and a second part, the transceiver device also comprising modulation means for modulating the first part and the second part by using a first modulation method and a second modulation method, respectively, and means for initializing said second modulation method by using said first part.

9. The transceiver device according to claim 8, comprising determining means for determining the phase of a last signal modulated by the first modulation method in the packet, correcting means for correcting the phase of the signal to be modulated between the modulation of said first and second parts on the basis of said determination, wherein the modulation of the second part is arranged to be continued by the phase modulation method by using the corrected signal phase.

10. The transceiver device according to claim 8, wherein the packet comprises at least an access code part, a header part, a synchronization sequence and a payload data part, and that in said first part, the packet code part and the header part of the packet are modulated by using the GFSK modulation method, and in said second part, the synchronization sequence and the payload data part of the packet are modulated by using the DPSK modulation method

11. A wireless communication system which comprises at least one wireless transmitter device for signal modulation and at least one wireless receiver device for signal demodulation for short-range wireless communication, which wireless communication system comprises transmission means for transmitting a signal in packet format, wherein each packet comprises at least a first part and a second part, the wireless communication system also comprising modulation means for modulating the first part and the second part by using a first modulation method and a second modulation method, respectively, and means for initializing said second modulation method by using said first part.

12. The wireless communication system according to claim 11, wherein said first modulation method is a frequency modulation method and said second modulation method is a phase modulation method.
